(19) United States
(12) Patent Application Publication
(10) Pub. No.: US 2007/0067429 A1
(43) Pub. Date: Mar. 22, 2007

(54) Delivery method for digital content based on stored, preferential, contextual, and/or situational data

(76) Inventors: Naveen K. Jain, Novato, CA (US); Shon Sherwood, Lafayette, CA (US)

Correspondence Address: Hugh R. Kress;Browning Bushman P.C., Suite 1800, 5718 Westheimer, Houston, TX, 77057, US

(21) Appl. No.: 11/435,592

(22) Filed: May 17, 2006

Related U.S. Application Data
(60) Provisional application No. 60/681,593, filed on May 17, 2005.

(51) Int. Cl. G06F 15/173

(52) U.S. Cl. 709/223

(57) ABSTRACT

A system and method for dissemination of digital content comprising an integrated content delivery system is established that allows content providers to bid for delivery of their content based on stored, preferential, contextual and or situational data. The system preferably includes a client application that can access stored, preferential, contextual and/or situational data from its origin or the user, communicate the data to a central processing server over a network, and accept content over a network for the user. The central processing server takes into account the market for content directly related to the data communicated by the client application including the amount content providers are willing to pay per transmission.

### RELATED APPLICATION DATA

This application claims the priority of prior U.S. provisional application Ser. No. 60/681,593 filed on May 17, 2005, which application is hereby incorporated by reference herein in its entirety.

### FIELD OF THE INVENTION

The present invention relates generally to the distribution of digital content, and more particularly relates to a system for distributing digital content based on preferences defined by the client, the client's environment, and/or other situational data.

### BACKGROUND OF THE INVENTION

As used herein, the term “content” shall be defined and construed in the broadest possible sense to encompass essentially any compilation of data in whatever form, including without limitation, computer data files of all kinds. Examples of content include without limitation, computer graphics files of various known file types and formats (e.g., .jpg, .gif, .pdf, .tif, etc . . . ), computer audio/sound files of various known file types and formats (e.g., .wav, .mp3, etc . . . ), text-based computer documents of various known file types and formats (e.g., .doc, .wpd., .rtf, .txt, etc . . . ), computer data files, computer applications, and so on. Digital content in the form of discrete “files” can be of any size, from one to millions or billions or more of digital bits.

Similarly, as used herein, the term “stored” as applied to digital content shall be defined and construed in the broadest possible sense, to encompass any instance where digital content is tangibly embodied, for any period of time (i.e., either “permanently” or “temporarily”) in any type storage medium, including, without limitation, on a magnetic tape or disk, on a compact disc (“CD”), CD-ROM, CD R/W, DVD, and computer memory (including without limitation, read-only memory (“ROM”), any type of random-access memory (“RAM”), or any other digital content storage medium presently known or to be developed in the future.

Also, as used herein, the term “distribution” as applied to digital content shall be defined and construed in the broadest possible sense to encompass any instance wherein digital content is communicated in any manner from one location to another. “Distribution” shall be used and construed to apply to any manner whatsoever for communication of digital content, including without limitation, communication of digital content over a network, transmission over a cabled or wireless connection from one storage medium to another, physical transport of a copy of digital content tangibly embodied in a storage medium (e.g., stored on a disk). Once distributed, digital content is likely to be capable of being viewed, displayed, watched, executed, listened to, or otherwise utilized by an end user, and in each case, such utilization may be made note of by one or more components of the system as a whole.

Finally, as used in this disclosure, the term “network” shall be defined and construed in the broadest possible sense, to encompass any mechanism by which digital content can be sent from one physical location to another. The term “network” can be used to describe all presently known types of networks, including without limitation local area networks (LANs) to which two or more computers have access, wide-area networks, the Internet (including any future generations or variations thereof, and so on. Moreover, the term “network” will include interconnections of two or more otherwise separate networks (which essentially describes the Internet, as would be apparent to anyone of ordinary skill in the art).

Using the foregoing broadest constructions, distribution of digital content can take on a great many forms. Physically transferring any tangible storage medium (e.g., CD, CD ROM, DVD, etc . . . ) containing digital data (e.g., an audio file, data) from one location to another would constitute an instance of distribution of digital content. Causing digital data of any sort to be communicated over a network, such as the Internet, from one stored location to another would constitute an instance of distribution of digital content. Even transferring digital content from one storage medium to another within a given computer system (for example, retrieval of a computer file from a mass storage device and storage of that file, or a copy thereof, in working memory accessed by the computer processing system), constitutes distribution of digital content as this concept is to be understood herein.

Regardless of what type of digital content is being considered, when considered broadly as discussed above, there are an essentially limitless number of instances where it may be desired to communicate digital content from one storage location to another, i.e., to distribute digital content.

One example (by no means the only) of distribution of digital content lies in the context of the distribution of digital copies of artistic works, such as music. Digital distribution of digital forms of musical works has in recent times been the subject of much debate, owing to the potential for abuses in the form of copyright infringement. Nevertheless, there are almost limitless legitimate and legal instances where the distribution of many types of digital content may be desirable.

Indeed, it is often the case that it is in the best interests of the creators and owners of digital content (i.e., artists, record labels, film studios, etc . . . ) to disseminate their content as widely as possible. This is especially true when such dissemination is associated with a payment to the content owners, i.e., when the content is being sold.

However, any particular end consumer of digital content will be likely to have an interest in only a small fraction of the overwhelmingly large volume of digital content that is available at any given time. That is to say, end consumers of digital content will have preferences as to the types and genres of digital content that are of interest to them. Thus, if content providers are to be successful in marketing their content to end consumers, it is important for the providers to target their content to consumers whose preferences match the content being offered. Heretofore, there has not been provided an efficient and effective means for enabling content providers to make their content available to a subset of the consuming public that is known to have a preference for the particular content offered by the provider.

### SUMMARY OF THE INVENTION

In view of the foregoing and other considerations, the present invention is directed to a method and system for distribution of content. Specifically, the present invention relates to a paid or unpaid delivery method for content, based on stored, preferential, contextual, and or situational data.

In one embodiment, an integrated content delivery system is established that allows content providers to bid for delivery of their content based on stored, preferential, contextual and or situational data. The system preferably includes a client application that can access stored, preferential, contextual and/or situational data from its origin or the user, communicate the data to a central processing server over a network, and receive and accept content either over a network or from a local content store, for the user. The central processing server takes into account the market for content directly related to the data communicated by the client application including the amount content providers are willing to pay per transmission.

In accordance with one aspect of the invention, content providers are able to pay for delivery of content based on preferences defined by the client, contextual data pertaining to the client's environment or state, and/or other situational data. The invention advantageously allows clients to receive content that is specific to their tastes and specific to their environment. The present invention further allows for the content delivery to be further controlled, if necessary and/or desired, by situational data relating to the client and/or parties involved in delivering the media content to the client, including the creators of the content. The client's environment is considered based on available data, such as location, physical environment, digital environment (such as but not limited to web page, document, or email content being interacted with or viewed by the client), and other relevant data that the media content provider wishes to consider to be representative of the client's environment. The invention improves dramatically upon existing systems by giving clients the ability to choose the media content that is most desirable to their tastes and then having the content provider respond by customizing the media content that is provided to the client. Content providers are able to reach specific clients based on their tastes, and are able to compete for specific “terms” communicated by the client to the server application.

In a preferred embodiment, the invention consists of a client application (the Client), and three server applications: the Record, which records client information and preferences; the Content Server, which delivers media content to the client(s); and the Market, which third-party distributors use to bid on contextual data and create, update, and analyze their portfolio. It is to be understood that the invention is subject to implementation in various forms and embodiments which may or may not include each of the components noted above. In particular, as will be hereinafter become apparent to those of ordinary skill in the art, the Market component is not necessarily essential in every implementation of the invention.

In one embodiment, the Client communicates with the Content Server over a network when performing various activities. The Content Server communicates with the Record, the Client, and, in some cases, the Market 18, when performing various activities. When utilized, the Market 18 communicates with the Content Server and the Record over a network when performing various activities. The Player can present content delivered from the Content Server to the user, get new content from the Content Server, send data to the Content Server resulting in changes to the list of content, get preferences from the client, store said preferences, and send said preferences to the Content Server.

### BRIEF DESCRIPTION OF THE DRAWINGS

The foregoing and other features and aspects of the subject invention will be best understood with reference to a detailed description of specific embodiments of the invention, which follow, when read in conjunction with the accompanying drawing, wherein:

FIG. 1 is a functional block diagram of a distribution infrastructure configured in accordance with one embodiment of the invention.

### DETAILED DESCRIPTION OF SPECIFIC EMBODIMENTS OF THE INVENTION

The disclosure that follows, in the interest of clarity, does not describe all features of actual implementations. It will be appreciated that in the development of any such actual implementation, as in any such project, numerous engineering and design decisions must be made to achieve the developers' specific goals and subgoals, which may vary from one implementation to another. Moreover, attention will necessarily be paid to proper engineering and programming practices for the environment in question. It will be appreciated that such a development effort might be complex and time-consuming, but would nevertheless be a routine undertaking for those of ordinary skill in the relevant field.

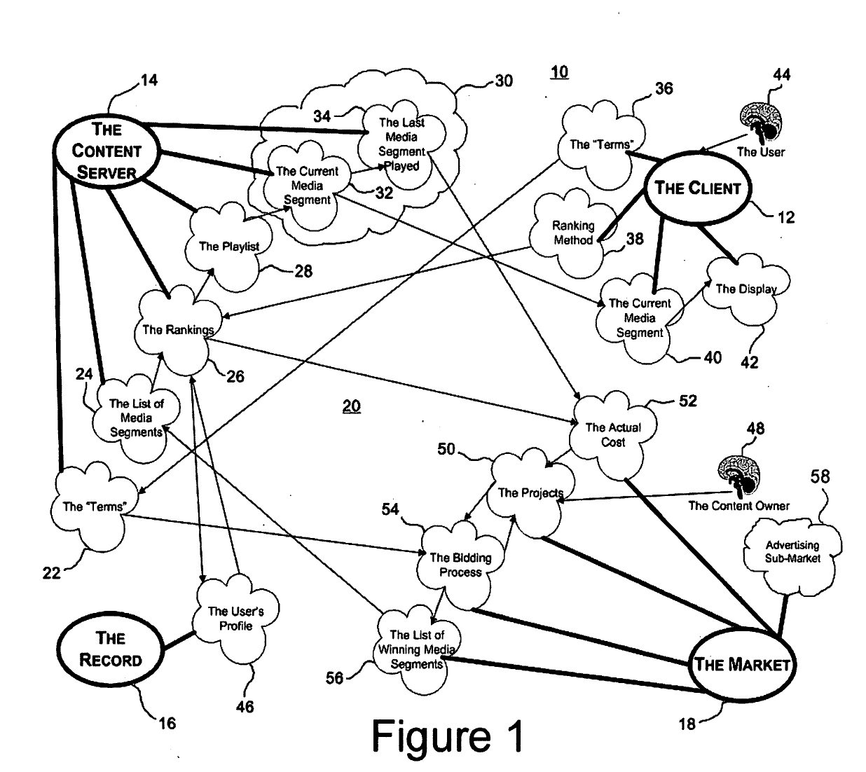

A specific embodiment 10 of the invention, that is to say, a specific contextual application of the invention, is illustrated in FIG. 1, and is described herein for the purposes of illustrating the salient features of the invention as a whole. It is to be understood, and believed that it will be readily understood, by those of ordinary skill in the art, that the practice of the present invention is by no means limited to the particular context(s) addressed in the present disclosure. It is specifically asserted that the present invention is not at all limited to application in the context of distributing musical works in a digital format, though as noted above this is believed to be one application for which the present invention may be particularly well-suited. Nor does each implementation of the invention necessarily include each component schematically represented in FIG. 1.

As shown in FIG. 1, the exemplary system 10 includes several primary components, including a Client 12, a Content Server 14, a Record 16, and a Market 18. Each of these components is described herein in terms of its functional operation, and it is to be understood that these functions are carried out, in the preferred embodiment, by means of software applications executed by conventional computational equipment, such as personal computers (laptop, desktop, handheld, etc . . . ), personal digital assistants (PDAs), portable media players (such as iPods® and MP3 players), cellular telephones, and so on, as would be familiar to those of ordinary skill in the art). That is, each functional component described herein is tangibly embodied by appropriate computational hardware and software programmed and configured to achieve the described functionality. It is believed that those of ordinary skill in the art would be readily able to implement the hardware and software necessary to achieve the functionality described herein, and that detailed descriptions of the programming details are not necessary to enable persons of ordinary skill in the art to practice the invention.

Each functional component of system 10 is capable of communicating with others by means of a network 20, for example (but not by way of limitation) the Internet (or any future generation or incarnation thereof), as would be understood by those of ordinary skill in the art. It is to be further understood that although the various functional components of system 10 are shown separately in FIG. 1, it is possible that more than one of the functionalities described hereinbelow may be carried out at a single location, or even by a single computer. For example, the functionalities of the Content Server 14 and the Record 16 could well be achieved by a single computer.

As will be hereinafter described in further detail, the functional components of system 10 are responsible for, among other things, maintaining a number of databases, including databases of information and content. For example, the Content Server maintains a database 22 of Terms (described further below) for each instantiation of Client 12, a listing 24 of media segments (e.g., a master songlist), a database 26 of user rankings; a database 28 of user playlists, a database 30 of media segments, preferably including a mechanism for identifying, for each user, a current media segment 32 and the most recently played media segment 34.

Client 12 includes means 36 for generating “Terms” (described below), and further includes a process 38 for generating rankings of media segments. Ranking process 38 is tangibly embodied in the hardware and software of client 12. Client 12 preferably also includes storage means 40 for storing one or more media segments, and a means 42 for presenting media segments to a user 44.

Record 16 functions to, among other things, maintain a database 46 of user profiles, including user rankings of media segments.

In one embodiment, the Market component 18 is responsible for obtaining content (i.e., media segments) from content owner/providers 48. In the presently disclosed embodiment, a media segment is any media content, such as a song, movie, TV episode, etc . . . , whether complete or partial, of any duration.

Market component 18 stores the content (or links thereto) (block 50) and maintains a database 52 of the actual cost of the content. Market 18 also supports a bid process 54 whereby content providers 48 associate monetary value(s), also referred to as bid(s), to one or more Terms assigned to a media segment provided by the content providers 48. Bid process 54 is further operable to generate “winning” media segment lists 56 based upon content providers' bids and Terms received from a Content Server 14, as will be hereinafter described in further detail. (Although only one content server 14 is shown in the exemplary embodiment of FIG. 1, it will be understood by those of ordinary skill in the art having the benefit of the present disclosure that the benefits of the invention are more fully realized if multiple content servers are involved. Similarly, while only one content provider 48 is shown in FIG. 1, the present invention is intended to involve many participating content providers 48.)

Client Application

With continued reference to FIG. 1, the exemplary system 10 includes at least one instantiation of a Client component 12. Although system 10 is shown as including only a single instantiation of a Client 12, those of ordinary skill in the art having the benefit of the present disclosure will appreciate that in an actual implementation of the invention, a large number of separate Clients 12 would exist. This is because the invention is intended to facilitate the mass distribution of content to a market comprising a great many content consumers (users). That is, benefits and advantages of system 10 are most fully realized in contexts which include multiple (preferably very many) Clients 12.

Each Client 12 provides its user 44 with a means 42 for listening to, viewing, playing, executing, or otherwise utilizing media segments, such as (without limitation) musical or video content, based on what the user is currently doing (for example, visiting a particular web page about a particular subject). Client 12 further enables the user to rank the media (process 38) benefiting both the user and the third-party media distributor that places the media in the system 10. User ranking is a process whereby a user interacts with Client 12 in such a way as to indicate a relative preference for (or against) a particular media segment, and wherein ranking process 38 communicates such user preferences to Content Server 14 via network 20.

In accordance with an important aspect of the invention, a Client 12 examines its environment and sends that information to a Content Server 14, which then sends media content back to the Player 12 for presentation. (As with Client 12, although only one Content Server 14 is shown in FIG. 1, it is contemplated that in actual implementation, system 10 would include a plurality of Content Servers.) As used herein, the term “environment” encompasses a number of different pieces of information, such as information about web sites user 44 is visiting, text on such web sites, metatag data from such web sites, as well as information local to the computer on which Client 12 is instantiated. Client 12 presents the content to the user 44, records the client's preferences related to the media segment, and sends those preferences to Content Server 14. This process repeats at the client's preference in one of two ways: exactly as thus far described, or, alternatively, without the examination of the environment and the communication of that data to Content Server 12.

The user 44 has the ability to define his or her preferences for content by ranking each media segment (for example, a song) on a scale as the segment is played. These preferences are recorded on the user's system, in the Record 16 (described below), or both. The Content Server 14 handles the saving of preferences to the Record 16, as will be hereinafter described in further detail.

Client display 42 preferably contains a section for advertisements. In accordance with one advantageous aspect of the invention, such advertisements may be contextual, for example, being based on the media segment 40 currently being delivered to Client 12. The media segment 40 and the advertisement are tied together on Content Server 14 for delivery to Client 12 based on situational data from the Market 18.

Descriptions of Items Included in Client 12

Scale/Ranking

In the exemplary embodiment, there are at least three options available for the scale on which media segments are ranked:

1. If a given media segment is associated with a one point scale (negative), the client preference will stop the segment from playing by updating the user's current play list in database 28 on Content Server 14 and prevent it from ever playing again for that user 44, by recording the user's preference in the Record 16, on the user's system, or both. The Content Server 14 handles saving of user profile data to The Record 16 (i.e., to database 46).

2. If a given media segment is associated with a two point scale (yes or no), a user 44 rating in the negative will stop the segment from playing by updating the current play list on the Content Server 14 and prevent it from ever playing again for that client by recording the client's preference in the Record 16, on the user's system, or both, as described above. On the other hand, if the user's rating is positive as to a particular media segment 40, the user's favorable preference will be recorded in Record 16, on the user's system, or both, in addition to being sent to The Content Server 14 to update the user's current play list in database 28. The Content Server 14 handles saving of data to The Record 16.

3. A given media segment may be associated with a scale of more than two points, with a negative ranking being on one end of the scale and a positive ranking on the other. All intermediate rankings between the negative and positive are recorded as a percentage of 100% positive or 100% negative. For example, on a six-point ranking scale (zero through five), where a zero ranking would represent the most negative preference and a five the most positive; a ranking of one would represent an intermediate, 20% positive ranking, a ranking of two would represent an intermediate 40% positive ranking, a ranking of three would represent an intermediate 60% positive ranking, and a ranking of four would represent an intermediate, 80% positive ranking. The actual numeric values used in the scale are irrelevant.

On such a multi-point scale with intermediate rankings between fully positive and fully negative, the user's preference for a particular media segment determines the likelihood of that media segment being played, based on threshold percentages and/or formulas definable by the Market 18 (described below). The users' preferences are recorded in the database 46 associated with Record 16, on the users' system, or both, in addition to being sent to the Content Server 14 to update the current play list. The Content Server 14 handles saving of data to the Record 16.

These rankings make their way into the Market 18 and help determine how much a third-party distributor is billed for the delivery of a given media segment. The Content Server 14 will not save rankings to the Record 16 if the user does not want the data to be stored there.

In accordance with one aspect of the invention, and in order that the benefits and advantages of the invention are fully realized, each Client component 12 is preferably executed on a platform, such as a personal computer or the like, that is preferably, but not necessarily connected to the Internet. Further, each client component 12 should preferably be able to take into account static and dynamic content in web pages visited by a user 44 by parsing visible text and non-visible text (html, java script, metadata, tags, etc) included in the page. Not all contextual data is necessarily dynamic, as the web site operator may choose to pass static “terms” 36 to Client 12. Client 12 can take into account images by parsing names and descriptions. Client 12 can take into account documents by parsing visible and non-visible text (embedded commands and tags). Client 12 can take into account other programs on the client's system by name and description. Client 12 can take into account previously viewed sites by parsing web browser history and cookies.

Each Client 12 communicates with a Content Server 14 via network 20 (e.g., the Internet) using a protocol such as TCP/IP. Client 12 contains an options menu wherein the user can select whether to store preference data in cookies within the user's web browser, in a file on disk, in memory, at a remote location on the network, or in the user profile database 46 maintained by Record 16. The Client 12 communicates this and all other preferences to Content Server 14 on startup and whenever a preference is changed.

In one embodiment, a means for the user 44 to select a particular rating scale (e.g., one point, two point, multiple point, as described above) to be used to rank Media Segments. For example, Client 12 may present user 44 an options menu wherein the user can select a scale and get descriptions of each.

Server Application (The Record 16)

Record 16 provides a central location to store data collected by the other components of system 10.

Record 16 receives information from Content Server 14 regarding media segment preferences, stores said information associating it with the given client 12, and makes that data available to Content Server 14 and to the Market 18.

Server Application (Content Server 14)

Content Server 14 sends media segments to Clients 12 after first fine-tuning the list of media to send based on user preferences, having previously received a list 56 of media content from the Market 18 that is biased to the highest bidder. The Content Server 14 fine-tunes the list of media on the fly based on input from the user 44, delivered through Client 12.

The Content Server 14 receives contextual data and user preferences from Client 12 and then delivers media content based on a list of media segments pulled from the Market 18 after modifying this list based on user preferences for certain media segments.

Descriptions of Items included in The Content Server

Process for Media Segment Delivery

The Content Server 14 receives a list 36 of Terms from the Client 12. The Content Server 14 saves user Terms in a database 22 and further communicates these Terms to the Market 18. The Market 18 provides a list 56 of all media segments associated with the terms ordered by highest average bid across the Terms. These lists are stored in a database 24 of all users' media segment lists. The Content Server 14 then checks the Record 18 to see if the user has ranked any of the media segments in the segment list. The list of media segments is processed from the highest average bid down. If the first media segment has been ranked negative by the user it is removed from the list and the next highest media segment checked for a ranking. This process is repeated until a non-negative result is returned. If the media segment is ranked positive, the segment is played at a reduced cost to the third-party distributor. The media content provider defines the rate of reduction, potentially playing the media segment for free for sufficiently high rankings. Once the media segment is played it is placed at the end of the list and the list is checked again from the top.

If the user has elected to store its own preferential data and not store that data in the Record 18, the above process differs in that the Content Server 14 communicates with Client 12 to check for media segment preferences, rather than with the Record 18.

Server Application (The Market 18)

The Market component 18 provides third-party distributors of media content the ability to disseminate their content to end users (content consumers) based on what the end users, are doing, reading, and so on; that is, the invention provides for contextual or situational targeting of content to end users. Third-party distributors pay for plays, and their content is only played when (i) a Term associated with their content is sent in from the user 44 via Content Server 14; (ii) the third-party distributor has the highest bid on that Term; and (iii) the user 44 has not ranked the content negatively.

For each Client 12, the Market 18 receives a list of Terms from the Content Server 14 and provides the Content Server 14 with a list of 56 media segments according to the process for media segment delivery. The Market 18 contains a section in which the media content provider can define various options. The Market 18 also contains a section that third-party distributors can access to bid on Terms, associate media segments with selected Terms, associate banner advertisements with media segments, and view statistics related to their portfolio of bids and delivered media segments.

An Advertisement Sub-Market 58 is a section of Market 18 that relates advertisements to media segments. Depending on the implementation, this relationship can be implemented using many different methods, either individually or in concert. One such method (but by no means the only method) is to select the advertisement to media segment relationships via directly associating advertisements to media segments, such as via a list. Another such method (again, by no means the only method) is to associate advertisements with keywords that are checked against the descriptive fields of each Third-Party Distributor and/or Media Segment in The Market. Another alternative method is to use Digital Content Fingerprinting to identify media segments and retrieve descriptions thereof in a database for the purpose of searching for keywords within the description of a given media segment.

As an illustrative example of the latter, assume that “Bob's Records” is a Third-Party Distributor with a media segment called “Bob's Song” in the Market 18. An advertiser wants to associate a given advertisement with any media segment with the keyword “bob” in the title. The advertiser places a bid amount on the keyword “bob” and associates it with the given advertisement. If the advertiser has the highest bid for the keyword “bob”, and if the media segment “Bob's Song” is sent to the user via the Content Server 14, such that when “Bob's Song” is played by the user's player, the associated advertisement will display for the duration of the media segment.

Media Content Provider Section

In the preferred embodiment, the operator of Market component 18, if any, maintains a web site through which the media content provider 48 can display statistics for anything in the Market 18 and set options such as the percentage to reduce the actual cost to the third-party distributor of a media segment delivered to a client, if the client has ranked the media segment positive, on a per-distributor basis.

Third-Party Distributor Section

Likewise, the operator of Market 18 preferably maintains a web site through which third-party distributors can bid on Terms, either directly associating a given Term with a given media segment, or by assigning a budget to a given Project (described below) and associating Terms with such Project. The distributor can also associate banner advertisements with media segments or with a Project. In addition, the distributor can specify preferences regarding how to bid on Terms.

Project

A Project is a set of media segments with a given budget and a specified list of Terms. Different media segments within a Project can be given different priorities, and the budget can be sectioned by media segment or Term. Priority is a function of the budget portion assigned to a given media segment within a Project, to be reduced as the money is spent. Priority may also be set based on time, so if a Project is to be active for a total of four weeks, the third-party distributor can elect, for example, to spend fifty percent of the budget in the third week. A database 50 of Projects is maintained by the Market 18.

Bids

Third-party distributors bid on Terms they associate with media segments that they place in the system 10. Bids start at an initial point defined by the operator of the Market component 18. Third-party distributors set their maximum bid per media segment, per Term, or per project, and the media segment with the highest average bid and highest set priority, if it is part of a project, is placed at the top of the list sent to Content Server 14. The second place on the list is given to the second highest bid, or, if the same third-party distributor that owns the first place on the list has another media segment with an equal priority as the first, that segment is placed in the second spot on the list. This process repeats on down the list until there are no more bids associated with media segments that are not already on the list.

Computation of Third-Party Distributor Charges

The third-party distributor is billed based on the bid amount, reduced by a reduction rate if the media segment was ranked positive, and only if the media segment was actually sent to Client 12. If the media segment was removed from the list on Content Server 14 because of a pre-existing negative ranking, the third-party distributor is not charged.

Reduction Rate

The reduction rate, if any, is set by the entity operating the Market 18, and defines the percentage to reduce the bid amount (for purposes of charging the third-party distributor) if the media segment is ranked positive.

Operation of system 10 starts with the process of creation of digital content. An artist, film maker, TV producer, or the like, produces a piece of content. This content may be, for example, a song or a film, although those of ordinary skill in the art will appreciate that the present invention can be advantageously applied to the dissemination of essentially any digital content.

If the content provider 48 is an artist, the artist may have access to the Market 18, but the artist's record label may have that access instead of the artist. If the content provider is a film maker, the film maker may have access to the Market 18, or it may be a film studio or some other party that has access to the Market 18. If the content provider is a TV producer, it is likely that the TV network that owns the show will be the party with access to Market 18.

The entity 48 having access to Market 18, also referred to as a third-party distributor, may not even necessarily need to own the content that it is placing “in” the system 10, because of the various different methods available to host the content. Placing the content in the system 10 can either involve actually physically putting the content in the system or it can be a link (for example, being implemented using a URL) to the content somewhere else on another server or network, or on the user's own hardware, that may be owned by a party not involved in system 10 at all.

Contracts are established between each third-party distributor and the entity operating Market 18. In one implementation, the entity operating the Market 18 is also the entity operating the Content Server 14, and the Record 16, although this is not necessarily the case in all implementations.

The Terms are keywords given to the Content Server 14 by Client 12, which the Content Server 14 then uses to get media segments from the Market 18 in order to formulate a playlist to return to the Client 12. In accordance with one aspect of the invention, if Client 12 is launched from a web page, it can get these keywords any number of ways. For example, Client 12 can be launched with the keywords as arguments or passed as parameters. In another example, Client 12, if launched from (for example) index.html, can go back to index_marconi.html (which will be nothing but keywords for index.html) and pull them from that separate page. The most elegant example involves output generated on-the-fly by a script (a PHP script, for example), so index.php generates an entire web page that also launches Client 12 with every visible word given to Client 12 as a parameter at run-time. A web page thus has to be “enabled” to use system 10 as presently implemented, however it is contemplated that in an alternative embodiment, Client 12 is able to just pull in any arbitrary data (words, numbers, etc . . . ) from anywhere on the user's computer and classify that data based on where it was found. This is what is referred to above as examining the user environment.

Description of Operation of the System

The present invention will be better understood with reference to a description of its operation. It is to be understood in the following description that the various specifics mentioned in the following example are purely hypothetical. Further, while the following example is described in the context of musical content, as previously noted the present invention is by no means limited to this contextual application.

Once content has been created (assume, in this example, that the content is a song), the artist takes this song to its record label. The record label, as the third-party distributor, decides to place this song into Market 18 to generate awareness of the song and artist. The record label sets a budget of $5,000 in the Market 18 for the playing of the song. The record label associates the terms (keywords) “hate love war kung-fu” with the song and sets valuations for these keywords to be “hate=$0.005”, “love=$0.010”, “war=$0.010”, and “kung-fu=$0.020.” Alternatively, a third-party distributor may specify that all songs that it places into the Market 18 have a particular group of terms associated therewith. As another alternative, terms may be specified globally to Market 18, making keyword values fixed across all third-party distributors who place content therein.

The third-party distributor, having entered the song into the Market 18, associated keywords with the song, and associated values with the keywords, has completed putting the song into the Market 18 for the artist.

Subsequently, every time Content Server 14 (or any Content Server that uses this particular instance of the Market 18) sends any of the keywords associated with the song (have, love, war, kung-fu) to the Market 18, this song will be on the list 56 of media segments returned to the Content Server 14 from the Market 18 (unless there is a limit on the number of media segments that can be returned, in which case that is not guaranteed). Where the song is located in the list 56 of media segments given to the Content Server 14 will depend on the bidding process (this happens automatically within the Market, much like with on-line auction sites such as Ebay, where bidders will enter in their maximum bid and the system bids for them) that happens within the Market 18 each time a list of keywords is given to it.

Now, if the song is given to the Content Server 14, the Content Server 14 will check the user profile database 46 associated with Record 16 to see if the current user has a pre-recorded rating for the song.

If the Record contains the user's rating for the song that is considered to be “negative” (definable, 0, or a separately definable range) the song will be removed from the user's 28 playlist before it is sent to the Client 12. Otherwise, the song will be on playlist 28 sent to Client 12, and will be played for the user (if the user keeps the Client open long enough for the song to be reached within the playlist 28.) The user has the ability to rate the song (mechanism 38), but may not elect to do so. If the user rates the song, that rating will be sent to the Content Server 14, which will save it in the user profile database 46 associated with Record 18. The Content Server 14 will then either remove the song (if the rating was considered “negative”) or issue a credit to the account of the third-party distributor. The Market 18 itself will define the amount of the credit to the third-party distributor's account based on conditions and values set by the operator of the Market 18, and the amount of the “bid” that was originally charged. The Content Server 14 will merely notify the Market 18 that it needs to issue a credit.

There are a number of conditions for retrieving a new playlist (stored in database 28). When Client 12 has finished playing all of the songs in its playlist, it will resend its “terms” (keywords) to the Content Server 14 in order to have a new playlist for user 44 established in database 28. This ensures that every play of every song is a paid-for play. A playlist in database 28 can be of any length, even a single song, and may be restricted to a set length by the operator of the Content Server 14 or of the Market 18, or potentially even by the user from within Client 12. If some songs on a playlist were not played, the implementation of system 10 may or may not allow for Client 12 to communicate the lack of play back to the Content Server 14 for the issuing of a credit.

In view of the foregoing, it will be apparent to those of ordinary skill in the art that the concept of “distribution” of digital content is separate from the concept of playing, viewing, executing, or otherwise utilizing the content. The content may be distributed from a central server, such as Content Server 14, but might also be accessed locally from storage connected directly or by some other means to the user's environment.

The Content Server 14 can be queried over a network for lists of available content (e.g., playlists), or, alternatively, Content Server 14 may be executed locally within the user environment, in concert with the client application 12. Built-in rules can be defined to handle content and the formation of playlists.

Importantly, it is to be noted that a content provider may be billed not merely upon initial transmission of content to a user's environment, but rather upon any utilization (playing, viewing, executing, etc . . . ) of the content by the user.

Those of ordinary skill in the art having the benefit of the present disclosure will further appreciate that the invention may be used in the distribution of content in a variety of applications, including, without limitation:
Promotion and distribution of music content
Promotion and distribution of multimedia content
Promotion and distribution of video content
Promotion and distribution of software
Promotion and distribution of advertisements
Promotion and distribution of product information
Promotion and distribution of government policy
Promotion and distribution of educational content and information
Promotion and distribution of electronic currency

The invention enables content owners to reach very specific groups of consumers who may be interested in like content, or additional content from the content author/owner. By allowing content owners to bid for “terms” transmitted in real time by the client media player application, the invention creates a “market” for access to specific groups of consumers. Instead of blanketing a significant quantity of outlets with sample content, the present invention advantageously enables content owners to target groups of consumers based on the terms that are generated by the local client application. This has the potential of significantly reducing the cost of marketing and advertising while at the same time reaching a wide range of consumers who may be interested in content from the content owner.

The invention also beneficially allows content owners to reach a larger number of consumers who may or may not visit high traffic destinations. Due to the client application's heavily distributed nature, content owners will encounter consumers who meet their specific requirements more frequently at a significant number of independent locations. This will result in increased penetration, awareness, and resulting sales for the content owner.

The benefits of the present invention, as presently contemplated by the inventors, include, without limitation:
Significantly increased segmentation of the consumer base for content owners with niche content;
The ability to reach consumers at a high number of independent, unrelated locations; and
The ability for content owners to measure their marketing and advertising budget and compete only for the specific terms that relate to their content.

From the foregoing description of one or more particular implementations of the invention, it should be apparent that a system and method for distribution of digital content has been disclosed which offers significant advantages over present distribution methodologies. Although a broad range of implementation details have been discussed herein, these are not to be taken as limitations as to the range and scope of the present invention as defined by the appended claims. A broad range of implementation-specific variations and alterations from the disclosed embodiments, whether or not specifically mentioned herein, may be practiced without departing from the spirit and scope of the invention as defined in the appended claims.

What is claimed is:

1. A system for dissemination of digital content in the form of a plurality of media segments, comprising:
a market component, adapted to maintain a database of media segments obtained from third parties, said third parties specifying, for each media segment in said media segment database, at least one bid term and an associated bid value for said at least one term;
a content server component, in communication with said market component, said content server component communicating to said market component at least one preferred term specified by an end user;
said market component being responsive to receipt of said preferred term to compile a list of media segments for which said third parties have specified said preferred term as said bid term, said market component communicating said list of media segments to said content server;
said content server being responsive to receipt of said list of media segments to transfer selected media segments on said list of media segments to said end user.

2. A system in accordance with claim 1, further comprising:
a client component, in communication with said content server component, said client component operable to communicate said at least one preferred term to said content server component.

3. A system in accordance with claim 2, wherein said client component comprises a ranking process for communicating to said content server user rankings of said media segments transferred to said user.

4. A system in accordance with claim 1, wherein said market component is coupled via a network to at least one third-party distributor of media segments.

5. A system in accordance with claim 1, wherein said market component compiles said list of media segments to include media segments whose associated bid values for said preferred term are highest among said database of media segments.

6. A system in accordance with claim 1, wherein each of said third-parties is charged each time its media segment is transferred to said end user.

7. A system in accordance with claim 3, wherein said user rankings include negative rankings and positive rankings.

8. A system in accordance with claim 7, wherein said user rankings include intermediate rankings.

9. A system in accordance with claim 7, wherein said content server is responsive to receipt of a negative ranking of a particular media segment from said user to omit said particular media segment from said list of media segments transferred to said end user.

10. A system in accordance with claim 3, further comprising:
a record component, in communication with said content server component, for maintaining a database of user profiles, each including said user rankings of media segments.

11. A system in accordance with claim 8, wherein said content server is responsive to receipt of an intermediate ranking of a particular media segment from a user to proportionally reduce the frequency with which said particular media segment is transferred to said user.

12. A system for dissemination of digital content in the form of a plurality of media segments, comprising:
a database of media segments obtained from third parties, said third parties specifying, for each media segment in said media segment database, at least one bid term and an associated bid value for said at least one term;
a content server component, in communication with said database of media segments, said content server component communicating to said database of media segments, at least one preferred term specified by an end user;
said database of media segments being responsive to receipt of said preferred term to compile a list of media segments for which said third parties have specified said preferred term as said bid term, said market component communicating said list of media segments to said content server;
said content server being responsive to receipt of said list of media segments to transfer selected media segments on said list of media segments to said end user.
